(19) United States
(12) Patent Application Publication
(10) Pub. No.: US 2009/0253586 A1
(43) Pub. Date: Oct. 8, 2009

(54) SUBSTRATES FOR MULTIPLEXED ASSAYS AND USES THEREOF

(75) Inventors: Bryce P. Nelson, Madison, WI (US); John C. Bart, Waunakee, WI (US); Bradley H. Garcia, Stoughton, WI (US)

Correspondence Address: Casimir Jones, S.C., 440 Science Drive, Suite 203, Madison, WI, 53711, US

(73) Assignee: GENTEL BIOSCIENCES, INC., Madison, WI (US)

(21) Appl. No.: 12/390,074

(22) Filed: Feb. 20, 2009

Related U.S. Application Data
(60) Provisional application No. 61/030,368, filed on Feb. 21, 2008.

(51) Int. Cl. C40B 30/04; C40B 40/00; C40B 40/08; C40B 40/10; C40B 60/12

(52) U.S. Cl. 506/9; 506/13; 506/17; 506/18; 506/39

(57) ABSTRACT

The present invention relates to novel methodologies for performing multiplexed assays for biological molecules such as proteins and nucleic acids. In particular, the present invention provides multiplexed assays using precipitating reagents and optically clear nitrocellulose-coated solid supports.

### CROSS REFERENCE TO RELATED APPLICATIONS

This application claims the benefit of U.S. Prov. Appl. 61/030,368 filed Feb. 21, 2008, the entire contents of which are herein incorporated by reference.

### FIELD OF THE INVENTION

The present invention relates to novel methodologies for performing multiplexed assays. In particular, the present invention provides multiplexed assays using precipitating reagents and optically clear nitrocellulose-coated solid supports.

### BACKGROUND OF THE INVENTION

Immunoassays are commonly used biochemical tests that measure the concentration of a target molecule in a biological or other sample. Immunoassays take advantage of the specific binding of an antibody or antibodies to a specific antigen and are used as a research tool in life sciences, as a diagnostic, and for quality control in various industries.

One common immunoassay is the Enzyme-Linked ImmunoSorbent Assay, or ELISA. In one example of a typical ELISA (also called a sandwich assay), a probe molecule is first immobilized on a polystyrene microplate or other surface. Next a blocking agent such as BSA is applied and incubated. A biological or other sample containing a specific target molecule (often a protein) of unknown concentration is made to come into contact with the immobilized probe molecule. If present, the target molecule is captured by the probe proportionally to the concentration of the target molecule. Next, the surface is typically washed with a mild detergent solution to remove any molecules that are not specifically bound. Next, an additional molecule, such as a second antibody, is applied to form a “sandwich” complex with the capture probe, target molecule, and labeled detector probe. The second molecule is often referred to as a detector probe or detector antibody, and is commonly covalently linked to an enzyme, hapten, or other labeling molecule.

After a final wash step the plate is developed by adding a conjugate that binds to the labeled detector antibody and contains an enzymatic substrate, fluorescently labeled detection reagent, or a variety of other reporters. The reporter produces a detectable signal proportional to the quantity of target antigen in the sample. Typically, ELISAs are read using a colorimetric or fluorescent plate reader and result in a single target analyte measurement per well.

In many cases, ELISAs are performed in microplates made to match a standardized format that enables processing via an automated instrument. These standards are established by the Society of Biomolecular Sciences (SBS) and are known as SBS standards. According to SBS standards, the “footprint” for a multiwell plate is approximately 85 mm×125 mm with wells located in a specified positions format depending upon the total number of wells. The American National Standards Institute (ANSI) has published the SBS Standards for microplates as: “Footprint Dimensions” (ANSI/SBS 1-2004), “Height Dimensions” (ANSI/SBS 2-2004), “Bottom Outside Flange Dimensions” (ANSI/SBS 3-2004) and “Well Positions” (ANSI/SBS 4-2004). Most commonly, ELISA users employ 96-wells in a single plate. Alternately, when less than 96-wells are needed in an assay, up to twelve 8-well “strips” can be employed such that only a portion of the 96-wells are used at a time.

Multiplexed immunoassays enable the simultaneous measurement of multiple proteins in a single test well. There are many advantages to performing multiplexed immunoassays, not the least of which is the conservation of sample, reagents, and cost, when measurements of multiple targets are required. There are a variety of approaches to multiplexing immunoassays, but most follow the general design and concept of immunoassays such as the ELISA. Bead-based systems are one example of a technology that enables the user to perform a multiplexed immunoassay. Bead-based systems employ color- or size-differentiated microspheres conjugated to different capture probes (such as antibodies) to capture multiple analytes of unknown concentration. To do this, conjugated beads are combined with sample to enable capture of the analyte of interest. Like an ELISA, detection occurs using a detector molecule such as a labeled antibody followed by detection reagent, such as fluorescently-labeled streptavidin. Also like an ELISA, a number of wash steps are performed during the procedure to remove non-specifically bound proteins. Readout is completed using a flow cytometry system that associates each probe molecule with a specific color or size of microsphere.

Planar arrays (also called microarrays, biochips, or chips) can also be used to generate multiplexed immunoassay data. Planar arrays generally comprise a collection of spatially addressable spots immobilized on a rigid solid support. Each spot generally contains a unique probe molecule (often capture antibodies) specific for a unique target analyte in a biological or other sample.

In many cases, the ability to perform multiplexed protein measurements on biological samples is useful for identifying and evaluating proteins with potential disease relevance and enabling critical decision making. Multiplexed assays can be important tools in the search for predictive protein biomarkers because identifying and/or validating these markers often requires analyzing multiple proteins in a large number of patient samples. Multiplexed protein measurement technology is particularly useful because it often can supply equivalent or superior precision, accuracy, and sensitivity than single-plex ELISA measurements in saliva, blood, plasma, serum, urine, or other biological fluids.

Multiplexed protein assays can also benefit diagnostics. One particularly useful aspect of the multiplexed assay is that can help reduce sample chain-of-custody concerns. This is because multiplexed assays consolidate multiple required tests into a single well performed at the same time. This can be particularly helpful for diagnosis of allergy, where hundreds of allergens can be immobilized to test for IgE and/or IgG reactivity in a patient serum sample. Other particularly useful applications include testing for the presence of autoimmune disease. Additionally, suspected cancer antigens can be immobilized to testing for the presence of cancer autoantibodies that might indicate presence of disease at an early stage.

Unfortunately, planar array technology requires very expensive and sensitive instrumentation generally based on confocal laser microarray scanners to achieve required sensitivity and reproducibility. Such scanners comprise a laser scanner for excitation of the fluorescent molecules, a pinhole for decreasing the noise fluorescent background, and a photomultiplier for increasing the sensitivity of the detection.

Expectations for the validation of biomarkers for use in a clinical or drug development setting are very high. Many of these expectations are outlined in documents developed in cooperation with the FDA (e.g., Drug-Diagnostic Co-Development Concept Paper, Department of Health and Human Services (HHS), Food and Drug Administration, April 2005; Guidance for Industry Bioanalytical Method Validation, U.S. Department of Health and Human Services, Food and Drug Administration, Center for Drug Evaluation and Research (CDER), Center for Veterinary Medicine (CVM), May 2001) and Evaluation Methods and Analytical Performance Characteristics of Immunological Assays for Human Immunoglobulin E (IgE) Antibodies of Defined Allergen Specificities; Approved Guideline, NCCLS DocumentI/LA20-A Vol 17 No 24. December 1997). As outlined in these and other documents, any assay that is to be considered for use in a drug development or clinical setting must be successfully validated for the fundamental parameters of accuracy, precision, selectivity, sensitivity, reproducibility, and stability. Among the most important performance attributes, an assay should meet minimal performance criteria based on accuracy, precision, and analyte recovery.

Since many potential protein biomarkers are often found at very low concentrations, any practical multiplex protein assay system must be sensitive enough to accurately and reproducibly quantify important proteins at physiologically relevant concentration in plasma serum, and other patient samples. Spot-to-spot, well-to-well, slide-to-slide, and run-to-run variation must be minimized in any practical system. The conjugation of protein probes to surfaces should be simple and the variation in surface chemistry within a slide, between slides, or within or between beads must be kept to a minimum. Assay variation due to detection instruments must also be kept to a minimum.

Additionally, methods for manufacture, processing, and analysis of protein microarray slides are arduous, labor intensive, and not compatible with the expectations of a typical ELISA user. These complicating factors make multiplexed immunoassays inaccessible to typical researchers, who merely want access to high-quality data at a reasonable cost.

Thus, there is a critical need for an affordable instrumentation and microarray surface chemistry combination that can generate sensitive and reproducible multiplexed immunoassay measurements. Ideally, this instrumentation would be coupled to a multiplexing system, software and ready-made multiplex immunoassay kits, and compatible with commercially available liquid handling and automation instrumentation.

### SUMMARY OF THE INVENTION

The present invention relates to novel methodologies for performing multiplexed assays. In particular, the present invention provides multiplexed assays using precipitating reagents and optically clear nitrocellulose-coated solid supports.

For example, in some embodiments, the present invention provides a method for performing a multiplexed assay, comprising: contacting a substrate with a sample comprising a target molecule under conditions such that the target molecule binds to a capture molecule, wherein the substrate comprises an array of the capture molecules affixed to an optically clear coating of nitrocellulose on the substrate to generate sample bound arrays; and contacting the sample bound arrays with reagents under conditions such that a precipitate is formed where the target molecule is bound to the capture molecule. In some embodiments, the method further comprises the step of determining the presence of the precipitate in discrete regions on the array, wherein the presence of the precipitate is indicative of the presence of the target molecule in the sample. In some embodiments, the method further comprises the step of quantifying the level of the target molecule in the sample. In some embodiments, the substrate is plastic or glass. In some embodiments, the precipitate is formed from the precipitate of a metallic compound (e.g. magnetic metallic compound) upon the complex of the target molecule and the capture molecule. In some embodiments, the precipitate is formed via a chemical reduction of silver in the presence of colloidal gold particles coupled to the bound target compound. In other embodiments, the precipitate is formed enzymatically, using horseradish peroxidase or Alkaline Phosphatase. Other examples of precipitating reactions include tyramide signal amplification. In some embodiments, determining the presence of the precipitate comprises the use of a calorimetric reader (e.g., a CCD, flatbed scanner, or CMOS based reader). In some embodiments, the array is selected from a 3″×1″ slide, a 96-well array plate, or a 384-well plate. In some embodiments, determining the presence of the precipitate comprises a detection assay selected from gold particle catalyzed silver deposition, horseradish peroxidase, AP, or tyramide signal amplification. In some embodiments, the capture molecule is selected from a nucleic acid, a protein (e.g., an antibody), and a small molecule. In some embodiments, the methods of the present invention provide a signal-to-noise of greater than 100, 200, 300, 400, 500, 600, 700, 800, 900, or 100, or from about 100 to 1000, 100 to 500, 200 to 500, 300 to 500. In some embodiments, these signal-to-noise ratios are achieved with a target molecule (e.g., antigen) concentration of from about 50 to 1000, 50 to 800, or 50 to 500 pg/ml, or from about 80 to 100, 80 to 800, or 80 to 500 pg/ml.

The present invention further provides a substrate comprising an array of capture molecules affixed to an optically clear coating of nitrocellulose on the substrate. In some embodiments, the substrate is plastic or glass. In some embodiments, the capture molecule is selected from a nucleic acid, a protein (e.g., an antibody), and a small molecule. In some embodiments, the substrates of the present invention provide a signal-to-noise of greater than 100, 200, 300, 400, 500, 600, 700, 800, 900, or 100, or from about 100 to 1000, 100 to 500, 200 to 500, 300 to 500. In some embodiments, these signal-to-noise ratios are achieved with a target molecule (e.g., antigen) concentration of from about 50 to 1000, 50 to 800, or 50 to 500 pg/ml, or from about 80 to 100, 80 to 800, or 80 to 500 pg/ml.

The present invention additionally provide systems and kits, comprising, for example: a substrate comprising an array of capture molecules affixed to an optically clear coating of nitrocellulose on the substrate; and a device for detection of target molecules bound to the capture molecules. In some embodiments, the system comprises reagents that form a precipitate where the target molecule is bound to the capture molecule. In some embodiments, the device detects the presence of a precipitate of the capture molecule and the target molecule on the array. In some embodiments, the device quantifies the level of the target molecule. In some embodiments, the substrate is plastic or glass. In some embodiments, the capture molecule is selected from a nucleic acid, a protein (e.g., an antibody), and a small molecule. In some embodiments, the device is a calorimetric reader (e.g., a CCD or CMOS based reader). In some embodiments, the array is selected from a 3″×1″ slide, a 96-well array plate, or a 384-well plate. In some embodiments, the systems and kits further comprise additional reagents or components useful, necessary, or sufficient for performing multiplexed assays. In some embodiments, the systems and kits of the present invention provide a signal-to-noise of greater than 100, 200, 300, 400, 500, 600, 700, 800, 900, or 100, or from about 100 to 1000, 100 to 500, 200 to 500, 300 to 500. In some embodiments, these signal-to-noise ratios are achieved with a target molecule (e.g., antigen) concentration of from about 50 to 1000, 50 to 800, or 50 to 500 pg/ml, or from about 80 to 100, 80 to 800, or 80 to 500 pg/ml.

### DESCRIPTION OF THE FIGURES

FIG. 1 shows a cartoon schematic of the components of a typical biochip.

FIG. 2 shows a cartoon schematic of various calorimetric assay schemes: (a) gold particle catalyzed silver deposition, (b) latex microparticles, and (c) enzyme-catalyzed precipitation.

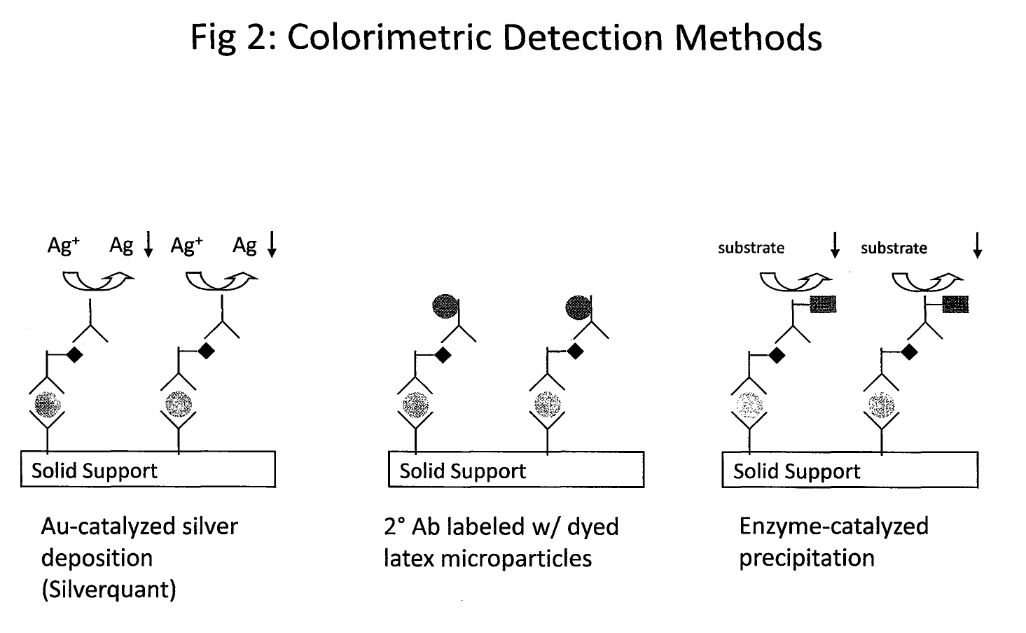

FIG. 3 shows a cartoon schematic of the human cytokine array layout on the slides.

FIG. 4 shows pictures of representative human cytokine arrays on (a) plastic slide with calorimetric assay, and (b) PATH™ slide with fluorescence assay.

FIG. 5 shows standard curves for the human cytokine assay run on plastic slides utilizing gold particle catalyzed silver deposition detection scheme.

FIG. 6 shows standard curves for the cytokine assay run on PATH™ slides utilizing the fluorescence detection scheme.

FIG. 7 shows standard curves for the human allergy (Der p 2) assay using (a) PATH™ slides with fluorescence detection and (b) plastic slides with calorimetric detection.

FIG. 8 shows the signal-to-noise for the detection of PiGF (phosphatidylinositol glycan anchor biosynthesis, class F) using an array-based multiplexed immunoassay and colorimetric detection reagents in a standard dilution curve. Sixteen arrays were printed on a single clear plastic slide coated with optically clear nitrocellulose and blocked using Gentel Block buffer. The array also contained VEGF (Vascular endothelial growth factor), PDGF (platelet derived growth factor), and FGF (Fibroblast Growth Factor). Noise is calculated using the signal generated at a blank spot on the array. A SIMplex 16 multiplexing device (Gentel Biosciences) was used to separate the sixteen individual arrays.

### DEFINITIONS

“Purified polypeptide” or “purified protein” or “purified nucleic acid” means a polypeptide or nucleic acid of interest or fragment thereof which is essentially free of, e.g., contains less than about 50%, preferably less than about 70%, and more preferably less than about 90%, cellular components with which the polypeptide or polynucleotide of interest is naturally associated.

The term “isolated” means that the material is removed from its original environment (e.g., the natural environment if it is naturally occurring). For example, a naturally-occurring polynucleotide or polypeptide present in a living animal is not isolated, but the same polynucleotide or DNA or polypeptide, which is separated from some or all of the coexisting materials in the natural system, is isolated. Such polynucleotide could be part of a vector and/or such polynucleotide or polypeptide could be part of a composition, and still be isolated in that the vector or composition is not part of its natural environment.

“Polypeptide” and “protein” are used interchangeably herein and include all polypeptides as described below. The basic structure of polypeptides is well known and has been described in innumerable textbooks and other publications in the art. In this context, the term is used herein to refer to any peptide or protein comprising two or more amino acids joined to each other in a linear chain by peptide bonds. As used herein, the term refers to both short chains, which also commonly are referred to in the art as peptides, oligopeptides and oligomers, for example, and to longer chains, which generally are referred to in the art as proteins, of which there are many types.

It will be appreciated that polypeptides often contain amino acids other than the 20 amino acids commonly referred to as the 20 naturally occurring amino acids, and that many amino acids, including the terminal amino acids, may be modified in a given polypeptide, either by natural processes, such as processing and other post-translational modifications, but also by chemical modification techniques which are well known to the art. Even the common modifications that occur naturally in polypeptides are too numerous to list exhaustively here, but they are well described in basic texts and in more detailed monographs, as well as in a voluminous research literature, and they are well known to those of skill in the art. Among the known modifications which may be present in polypeptides of the present are, to name an illustrative few, acetylation, acylation, ADP-ribosylation, amidation, covalent attachment of flavin, covalent attachment of a heme moiety, covalent attachment of a nucleotide or nucleotide derivative, covalent attachment of a lipid of lipid derivative, covalent attachment of phosphatidylinositol, cross-linking, cyclization, disulfide bond formation, demethylation, formation of covalent cross-links, formation of cystine, formation of pyroglutamate, formylation, gamma-carboxylation, glycosylation, GPI anchor formation, hydroxylation, iodination, methylation, myrisoylation, oxidation, proteolytic processing, phosphorylation, prenylation, racemization, selenoylation, sulfation, transfer-RNA mediated addition of amino acids to proteins such as arginylation, and ubiquitination.

Such modifications are well known to those of skill and have been described in great detail in the scientific literature. Several particularly common modifications, glycosylation, lipid attachment, sulfation, gamma-carboxylation of glutamic acid residues, hydroxylation and ADP-ribosylation, for instance, are described in most basic texts, such as for instance Proteins—Structure and Molecular Properties, 2.sup.nd Ed., T. E. Creighton, W. H. Freeman and Company, New York (1993). Many detailed reviews are available on this subject, such as, for example, those provided by Wold, F., Posttranslational Protein Modifications: Perspectives and Prospects, pg. 1-12 in Posttranslational Covalent Modification of Proteins, B. C. Johnson, Ed., Academic Press, New York (1983); Seifter et al., Analysis for protein modifications and nonprotein cofactors, Meth. Enzymol. 182: 626-646 (1990) and Rattan et al., Protein synthesis: Posttranslational Modifications and Aging, Ann N.Y. Acad. Sci. 663: 48-62 (1992).

It will be appreciated, as is well known and as noted above, that polypeptides are not always entirely linear. For instance, polypeptides may be branched as a result of ubiquitination, and they may be circular, with or without branching, generally as a result of posttranslational events, including natural processing events and events brought about by human manipulation which do not occur naturally. Circular, branched, and branched circular polypeptides may be synthesized by non-translational natural process and by entirely synthetic methods as well.

Modifications can occur anywhere in a polypeptide, including the peptide backbone, the amino acid side-chains and the amino or carboxyl termini. In fact, blockage of the amino or carboxyl group in a polypeptide, or both, by a covalent modification, is common in naturally occurring and synthetic polypeptides. For instance, the amino terminal residue of polypeptides made in E. coli, prior to proteolytic processing, almost invariably will be N-formylmethionine.

The modifications that occur in a polypeptide often will be a function of how it is made. For polypeptides made by expressing a cloned gene in a host, for instance, the nature and extent of the modifications in large part will be determined by the host cell posttranslational modification capacity and the modification signals present in the polypeptide amino acid sequence. For instance, as is well known, glycosylation often does not occur in bacterial hosts such as E. coli. Accordingly, when glycosylation is desired, a polypeptide should be expressed in a glycosylating host, generally a eukaryotic cell. Insect cells often carry out the same posttranslational glycosylations as mammalian cells, and, for this reason, insect cell expression systems have been developed to express efficiently mammalian proteins having native patterns of glycosylation. Similar considerations apply to other modifications.

It will be appreciated that the same type of modification may be present in the same or varying degree at several sites in a given polypeptide. Also, a given polypeptide may contain many types of modifications.

In general, as used herein, the term polypeptide encompasses all such modifications, particularly those that are present in polypeptides synthesized by expressing a polynucleotide in a host cell.

The term “mature” polypeptide refers to a polypeptide which has undergone a complete, post-translational modification appropriate for the subject polypeptide and the cell of origin.

A “fragment” of a specified polypeptide refers to an amino acid sequence which comprises at least about 3-5 amino acids, more preferably at least about 8-10 amino acids, and even more preferably at least about 15-20 amino acids derived from the specified polypeptide.

The term “immunologically identifiable with/as” refers to the presence of epitope(s) and polypeptide(s) which also are present in and are unique to the designated polypeptide(s). Immunological identity may be determined by antibody binding and/or competition in binding. The uniqueness of an epitope also can be determined by computer searches of known data banks, such as GenBank, for the polynucleotide sequence which encodes the epitope and by amino acid sequence comparisons with other known proteins.

As used herein, “epitope” means an antigenic determinant of a polypeptide or protein. Conceivably, an epitope can comprise three amino acids in a spatial conformation which is unique to the epitope. Generally, an epitope consists of at least five such amino acids and more usually, it consists of at least eight to ten amino acids. Methods of examining spatial conformation are known in the art and include, for example, x-ray crystallography and two-dimensional nuclear magnetic resonance.

A “conformational epitope” is an epitope that is comprised of a specific juxtaposition of amino acids in an immunologically recognizable structure, such amino acids being present on the same polypeptide in a contiguous or non-contiguous order or present on different polypeptides.

A polypeptide is “immunologically reactive” with an antibody when it binds to an antibody due to antibody recognition of a specific epitope contained within the polypeptide. Immunological reactivity may be determined by antibody binding, more particularly, by the kinetics of antibody binding, and/or by competition in binding using as competitor(s) a known polypeptide(s) containing an epitope against which the antibody is directed. The methods for determining whether a polypeptide is immunologically reactive with an antibody are known in the art.

As used herein, the term “immunogenic polypeptide containing an epitope of interest” means naturally occurring polypeptides of interest or fragments thereof, as well as polypeptides prepared by other means, for example, by chemical synthesis or the expression of the polypeptide in a recombinant organism.

“Purified product” refers to a preparation of the product which has been isolated from the cellular constituents with which the product is normally associated and from other types of cells which may be present in the sample of interest.

“Analyte,” as used herein, is the substance to be detected which may be present in the test sample, including, biological molecules of interest, small molecules, pathogens, and the like. The analyte can include a protein, a polypeptide, an amino acid, a nucleotide target and the like. The analyte can be soluble in a body fluid such as blood, blood plasma or serum, urine or the like. The analyte can be in a tissue, either on a cell surface or within a cell. The analyte can be on or in a cell dispersed in a body fluid such as blood, urine, breast aspirate, or obtained as a biopsy sample.

As used herein, the term “probe” refers to the entity in a biochemical assay that binds the “target” or “analyte” contained in the sample being tested.

As used herein, the term “target” refers to the entity that is being detected in an assay. In some embodiments, the term “target” is equivalent to “analyte”.

As used herein, the term “detector” refers to a reagent that binds specifically to the “target” or “analyte” and contains a moiety that allows that target to be measured. In some embodiments, detectors include, but are not limited to, a “labeling molecule”, an enzyme, a fluorescent dye, etc.

A “specific binding member,” as used herein, is a member of a specific binding pair. That is, two different molecules where one of the molecules, through chemical or physical means, specifically binds to the second molecule. Therefore, in addition to antigen and antibody specific binding pairs of common immunoassays, other specific binding pairs can include biotin and avidin, carbohydrates and lectins, complementary nucleotide sequences, effector and receptor molecules, cofactors and enzymes, enzyme inhibitors, and enzymes and the like. Furthermore, specific binding pairs can include members that are analogs of the original specific binding members, for example, an analyte-analog. Immunoreactive specific binding members include antigens, antigen fragments, antibodies and antibody fragments, both monoclonal and polyclonal and complexes thereof, including those formed by recombinant DNA molecules.

Specific binding members include “specific binding molecules.” A “specific binding molecule” intends any specific binding member, particularly an immunoreactive specific binding member. As such, the term “specific binding molecule” encompasses antibody molecules (obtained from both polyclonal and monoclonal preparations), as well as, the following: hybrid (chimeric) antibody molecules (see, for example, Winter, et al., Nature 349: 293-299 (1991), and U.S. Pat. No. 4,816,567); F(ab′).sub.2 and F(ab) fragments; Fv molecules (non-covalent heterodimers, see, for example, Inbar, et al., Proc. Natl. Acad. Sci. USA 69: 2659-2662 (1972), and Ehrlich, et al., Biochem. 19: 4091-4096 (1980)); single chain Fv molecules (sFv) (see, for example, Huston, et al., Proc. Natl. Acad. Sci. USA 85: 5879-5883 (1988)); humanized antibody molecules (see, for example, Riechmann, et al., Nature 332: 323-327 (1988), Verhoeyan, et al., Science 239: 1534-1536 (1988), and UK Patent Publication No. GB 2,276,169, published 21 Sep. 1994); and, any functional fragments obtained from such molecules, wherein such fragments retain immunological binding properties of the parent antibody molecule.

The term “hapten,” as used herein, refers to a partial antigen or non-protein binding member which is capable of binding to an antibody, but which is not capable of eliciting antibody formation unless coupled to a carrier protein.

A “capture reagent,” as used herein, refers to an unlabeled specific binding member which is specific either for the analyte as in a sandwich assay, for the indicator reagent or analyte as in a competitive assay, or for an ancillary specific binding member, which itself is specific for the analyte, as in an indirect assay. The capture reagent can be directly or indirectly bound to a solid phase material before the performance of the assay or during the performance of the assay, thereby enabling the separation of immobilized complexes from the test sample.

The “indicator reagent” comprises a “signal-generating compound” (“label”) which is capable of generating and generates a measurable signal detectable by external means. In some embodiments, the indicator reagent is conjugated (“attached”) to a specific binding member. In addition to being an antibody member of a specific binding pair, the indicator reagent also can be a member of any specific binding pair, including either hapten-anti-hapten systems such as biotin or anti-biotin, avidin or biotin, a carbohydrate or a lectin, a complementary nucleotide sequence, an effector or a receptor molecule, an enzyme cofactor and an enzyme, an enzyme inhibitor or an enzyme and the like. An immunoreactive specific binding member can be an antibody, an antigen, or an antibody/antigen complex that is capable of binding either to the polypeptide of interest as in a sandwich assay, to the capture reagent as in a competitive assay, or to the ancillary specific binding member as in an indirect assay. When describing probes and probe assays, the term “reporter molecule” may be used. A reporter molecule comprises a signal generating compound as described hereinabove conjugated to a specific binding member of a specific binding pair, such as carbazole or adamantane.

The various “signal-generating compounds” (labels) contemplated include chromagens, catalysts such as enzymes, luminescent compounds such as fluorescein and rhodamine, chemiluminescent compounds such as dioxetanes, acridiniums, phenanthridiniums and luminol, radioactive elements and direct visual labels. Examples of enzymes include alkaline phosphatase, horseradish peroxidase, beta-galactosidase and the like. The selection of a particular label is not critical, but it should be capable of producing a signal either by itself or in conjunction with one or more additional substances.

“Solid phases” (“solid supports”) are known to those in the art and include the walls of wells of a reaction tray, test tubes, polystyrene beads, magnetic or non-magnetic beads, nitrocellulose strips, membranes, microparticles such as latex particles, and others.

The “solid phase” is not critical and can be selected by one skilled in the art. Thus, latex particles, microparticles, magnetic or non-magnetic beads, membranes, plastic tubes, walls of microtiter wells, glass or silicon chips, are all suitable examples. It is contemplated and within the scope of the present invention that the solid phase also can comprise any suitable porous material.

As used herein, the terms “detect”, “detecting”, or “detection” may describe either the general act of discovering or discerning or the specific observation of a detectably labeled composition.

The term “polynucleotide” refers to a polymer of ribonucleic acid (RNA), deoxyribonucleic acid (DNA), modified RNA or DNA, or RNA or DNA mimetics. This term, therefore, includes polynucleotides composed of naturally-occurring nucleobases, sugars and covalent internucleoside (backbone) linkages as well as polynucleotides having non-naturally-occurring portions which function similarly. Such modified or substituted polynucleotides are well-known in the art and for the purposes of the present invention, are referred to as “analogues.”

As used herein, the term “nucleic acid molecule” refers to any nucleic acid containing molecule, including but not limited to, DNA or RNA. The term encompasses sequences that include any of the known base analogs of DNA and RNA including, but not limited to, 4-acetylcytosine, 8-hydroxy-N-6-methyladenosine, aziridinylcytosine, pseudoisocytosine, 5-(carboxyhydroxylmethyl) uracil, 5-fluorouracil, 5-bromouracil, 5-carboxymethylaminomethyl-2-thiouracil, 5-carboxymethylaminomethyluracil, dihydrouracil, inosine, N6-isopentenyladenine, 1-methyladenine, 1-methylpseudouracil, 1-methylguanine, 1-methylinosine, 2,2-dimethylguanine, 2-methyladenine, 2-methylguanine, 3-methylcytosine, 5-methylcytosine, N6-methyladenine, 7-methylguanine, 5-methylaminomethyluracil, 5-methoxyaminomethyl-2-thiouracil, beta-D-mannosylqueosine, 5′-methoxycarbonylmethyluracil, 5-methoxyuracil, 2-methylthio-N6-isopentenyladenine, uracil-5-oxyacetic acid methylester, uracil-5-oxyacetic acid, oxybutoxosine, pseudouracil, queosine, 2-thiocytosine, 5-methyl-2-thiouracil, 2-thiouracil, 4-thiouracil, 5-methyluracil, N-uracil-5-oxyacetic acid methylester, uracil-5-oxyacetic acid, pseudouracil, queosine, 2-thiocytosine, and 2,6-diaminopurine.

The term “gene” refers to a nucleic acid (e.g., DNA) sequence that comprises coding sequences necessary for the production of a polypeptide, precursor, or RNA (e.g., rRNA, tRNA). The polypeptide can be encoded by a full length coding sequence or by any portion of the coding sequence so long as the desired activity or functional properties (e.g., enzymatic activity, ligand binding, signal transduction, immunogenicity, etc.) of the full-length or fragment are retained. The term also encompasses the coding region of a structural gene and the sequences located adjacent to the coding region on both the 5′ and 3′ ends for a distance of about 1 kb or more on either end such that the gene corresponds to the length of the full-length mRNA. Sequences located 5′ of the coding region and present on the mRNA are referred to as 5′ non-translated sequences. Sequences located 3′ or downstream of the coding region and present on the mRNA are referred to as 3′ non-translated sequences. The term “gene” encompasses both cDNA and genomic forms of a gene. A genomic form or clone of a gene contains the coding region interrupted with non-coding sequences termed “introns” or “intervening regions” or “intervening sequences.” Introns are segments of a gene that are transcribed into nuclear RNA (hnRNA); introns may contain regulatory elements such as enhancers. Introns are removed or “spliced out” from the nuclear or primary transcript; introns therefore are absent in the messenger RNA (mRNA) transcript. The mRNA functions during translation to specify the sequence or order of amino acids in a nascent polypeptide.

The term “nucleic acid amplification reagents” includes conventional reagents employed in amplification reactions and includes, but is not limited to, one or more enzymes having polymerase activity, enzyme cofactors (such as magnesium or nicotinamide adenine dinucleotide (NAD)), salts, buffers, deoxynucleotide triphosphates (dNTPs; for example, deoxyadenosine triphosphate, deoxyguanosine triphosphate, deoxycytidine triphosphate and deoxythymidine triphosphate) and other reagents that modulate the activity of the polymerase enzyme or the specificity of the primers.

As used herein, the terms “complementary” or “complementarity” are used in reference to polynucleotides (i.e., a sequence of nucleotides such as an oligonucleotide or a target nucleic acid) related by the base-pairing rules. Complementarity may be “partial,” in which only some of the nucleic acids' bases are matched according to the base pairing rules. Or, there may be “complete” or “total” complementarity between the nucleic acids. The degree of complementarity between nucleic acid strands has significant effects on the efficiency and strength of hybridization between nucleic acid strands. This is of particular importance in amplification reactions, as well as detection methods which depend upon binding between nucleic acids.

The term “homology” refers to a degree of identity. There may be partial homology or complete homology. A partially identical sequence is one that is less than 100% identical to another sequence.

As used herein, the term “hybridization” is used in reference to the pairing of complementary nucleic acids. Hybridization and the strength of hybridization (i.e., the strength of the association between the nucleic acids) is impacted by such factors as the degree of complementary between the nucleic acids, stringency of the conditions involved, the Tm of the formed hybrid, and the G:C ratio within the nucleic acids.

As used herein, the term “Tm” is used in reference to the “melting temperature.” The melting temperature is the temperature at which a population of double-stranded nucleic acid molecules becomes half dissociated into single strands. The equation for calculating the Tm of nucleic acids is well known in the art. As indicated by standard references, a simple estimate of the Tm value may be calculated by the equation: Tm=81.5+0.41(% G+C), when a nucleic acid is in aqueous solution at 1 M NaCl (see e.g., Anderson and Young, Quantitative Filter Hybridization, in Nucleic Acid Hybridization (1985). Other references include more sophisticated computations which take structural as well as sequence characteristics into account for the calculation of Tm.

As used herein the term “stringency” is used in reference to the conditions of temperature, ionic strength, and the presence of other compounds, under which nucleic acid hybridizations are conducted. With “high stringency” conditions, nucleic acid base pairing will occur only between nucleic acid fragments that have a high frequency of complementary base sequences. Thus, conditions of “weak” or “low” stringency are often required when it is desired that nucleic acids which are not completely complementary to one another be hybridized or annealed together.

The term “wild-type” refers to a gene or gene product which has the characteristics of that gene or gene product when isolated from a naturally occurring source. A wild-type gene is that which is most frequently observed in a population and is thus arbitrarily designed the “normal” or “wild-type” form of the gene. In contrast, the term “modified” or “mutant” refers to a gene or gene product which displays modifications in sequence and or functional properties (i.e., altered characteristics) when compared to the wild-type gene or gene product. It is noted that naturally-occurring mutants can be isolated; these are identified by the fact that they have altered characteristics when compared to the wild-type gene or gene product.

The term “oligonucleotide” as used herein is defined as a molecule comprised of two or more deoxyribonucleotides or ribonucleotides, preferably at least 5 nucleotides, more preferably at least about 10-15 nucleotides and more preferably at least about 15 to 30 nucleotides, or longer. The exact size will depend on many factors, which in turn depends on the ultimate function or use of the oligonucleotide. The oligonucleotide may be generated in any manner, including chemical synthesis, DNA replication, reverse transcription, or a combination thereof.

Because mononucleotides are reacted to make oligonucleotides in a manner such that the 5′ phosphate of one mononucleotide pentose ring is attached to the 3′ oxygen of its neighbor in one direction via a phosphodiester linkage, an end of an oligonucleotide is referred to as the “5′ end” if its 5′ phosphate is not linked to the 3′ oxygen of a mononucleotide pentose ring and as the “3′ end” if its 3′ oxygen is not linked to a 5′ phosphate of a subsequent mononucleotide pentose ring. As used herein, a nucleic acid sequence, even if internal to a larger oligonucleotide, also may be said to have 5′ and 3′ ends. A first region along a nucleic acid strand is said to be upstream of another region if the 3′ end of the first region is before the 5′ end of the second region when moving along a strand of nucleic acid in a 5′ to 3′ direction.

When two different, non-overlapping oligonucleotides anneal to different regions of the same linear complementary nucleic acid sequence, and the 3′ end of one oligonucleotide points towards the 5′ end of the other, the former may be called the “upstream” oligonucleotide and the latter the “downstream” oligonucleotide. The term “primer” refers to an oligonucleotide which is capable of acting as a point of initiation of synthesis when placed under conditions in which primer extension is initiated. An oligonucleotide “primer” may occur naturally, as in a purified restriction digest or may be produced synthetically.

As used herein, the term “quantitative” refers to an assay system that produces a numerical measure of the concentration of an analyte (e.g., protein), in the test specimen. In some embodiments, quantitative measurements are accurate and reproducible. In some embodiments, quantitative are analyzed using homologous or heterologous interpolation from a calibration curve, which is referenced to a readily available standard reference preparation. In some embodiments, the result of a quantitative assay for a particular analyte is reported in gravimetric units (e.g. 15 ng/mL) or international units (e.g. 73.5 IU).

As used herein, the term “semi-quantitative” refers to an assay system that defines the magnitude of a response. The variations in positive can be measured and assigned a range or category. For example, in some embodiments, a semi-quantitative assay states that an analyte concentration is “high”, “medium”, “low” or “absent”, but does not assign a specific value to that concentration.

As used herein, the term “qualitative” refers to an assay system that produces an indication of the presence or absence of an analyte but does not provide a numerical measure of the concentration of that analyte. For example, a positive test results indicates that the assay signal exceeds the analytical threshold or positive cutoff point that has been set to an arbitrary combination of diagnostic sensitivity and specificity.

As used herein, the term “solid support” refers to a rigid, non-reactive material that is used as a foundation for, but doesn't participate in, a biological assay. Examples include, but are not limited to, glass microscope slides.

As used herein, the term “biological process” refers to processes that occur in biological systems. Examples include, but are not limited to, transcription, recombination, and DNA repair.

As used herein, the term “array” refers to a grouping of multiple entities (e.g., biomolecules) that are spatially separated in two dimensions on a surface in a square or rectangular arrangement. Arrays are defined by the number of rows and columns of these entities.

As used herein, the term “labeling molecule” refers to a molecule that is chemically bound to another molecule to enable sensitive and specific recognition by another molecule. One example of a labeling molecule is biotin, which binds to streptavidin, labeled streptavidin, anti-biotin, and fluorescently-labeled anti-biotin. Another example of a labeling molecule is fluorescein, which binds to anti-fluorescein, and fluorescently labeled anti-fluorescein antibodies.

As used herein, the term “biological entity” refers to any molecular arrangement that contains physical forces, such as hydrogen bonding, ionic bonding, covalent bonding, polar attractions and van der Waals forces that interact with molecules in a biological system or any molecular arrangement derived from a biological system in whole or in part including, but not limited to, nucleotides, proteins, inhibitors, receptors, and molecular arrangements fabricated to interact with or be a part of biological molecules including known naturally and non-naturally occurring therapeutic agonist and antagonists.

As used herein, the term “blocking agent” refers to a molecular arrangement that will absorb to a surface with probe molecules attached. The absorption can result because of non-covalent bonding attractive forces or because the blocking agent contains a reactive group. For example, a polyethylene glycol group can act as a blocking agent when it is covalently bonded to the surface or the protein bovine serum albumin can act as a blocking agent when it is non-covalently attached to the surface.

As used herein, the term “fusion protein” refers to a protein that contains additional molecular arrangements from those found in nature including, but not limited to, naturally or non-naturally amino acids. Fusion proteins are generally the result of producing the protein by manipulating biological processes.

As used herein, the term “linker” refers to a molecular arrangement with a reactive group that binds a biological entity by exposure to the reactive group resulting in a biological entity linked to the molecular arrangement. The linker includes the molecular arrangements before and after the reactive group binds to the biological entity.

As used herein, the term “sample” is used in its broadest sense. In one sense, it is meant to include a specimen or culture obtained from any source, as well as biological and environmental samples. Biological samples may be obtained from animals (including humans) and encompass fluids, solids, tissues, and gases. Biological samples include blood products, such as plasma, serum and the like. Environmental samples include environmental material such as surface matter, soil, water, crystals and industrial samples. Such examples are not however to be construed as limiting the sample types applicable to the present invention.

As used herein, the term signal-to-noise or signal-to-noise ratio refer to the ratio of signal strength (e.g., colorimetric signal due to a binding event on a predetermined area on a substrate surface as quantified, for example, by a plate reader or other scanning device) compared to noise for the same area (e.g., as determined from a predetermined blank area of the substrate surface by the plate reader or scanning device).

### DETAILED DESCRIPTION OF THE INVENTION

The present invention relates to novel methodologies for performing multiplexed assays. In particular, the present invention provides multiplexed assays using precipitating reagents and optically clear nitrocellulose-coated solid supports, preferably polymeric (e.g., plastic) supports.

The present invention relates to novel methodologies for performing multiplexed assays with high sensitivity using low-cost materials. In some embodiments, probe arrays on solid supports coated with nitrocellulose-containing materials are combined with detection methods that form a precipitate at discrete regions to enable identification and/or a quantification of target compounds. The amount of the precipitate(s) at specific region(s) can be detected and used to quantify the concentration of target analytes in a test solution.

### I. Systems

In some embodiments, the present invention provides devices (e.g., arrays and array detectors) and systems for performing biological assays. Exemplary systems are described below.

### A. Arrays

In some embodiments, the present invention provides arrays of biological molecules for diagnostic and research applications. In some embodiments, arrays are fabricated by the immobilization of biomolecules at discrete sites on a functionalized surface.

i. Solid Supports

In some embodiments, the biochip surface includes a solid support. A number of materials can be used as solid supports including, but not limiting to, silicon rubber, glass, organic polymer, inorganic polymer, and combinations thereof. In some embodiments, optically clear plastics, such as polystyrene, polycarbonate, poly(methyl methacrylate), polyurethane or polyamide are utilized. In some embodiments, the solid support is made of high-density polyethylene, low-density polyethylene, polypropylene, cellulose acetate, vinyl, plasticized vinyl, cellulose acetate butyrate, melamine-formaldehyde, polyester, or nylon. In some embodiments, materials are injection molded to match the dimensions of a standard microscope slide.

In some embodiments, solid supports are planar surfaces (e.g., microscope slides). In other embodiments, solid supports are non-planar surfaces. Such non-planar carrier surfaces include, but are not limited to, a microplate well or a microfluidics device. For example, in some embodiments, the array is selected from a 3″×1″ slide, a 96-well array plate, or a 384-well plate.

In some embodiments, the slide is proportioned so that after microarray printing, the slide can be joined with a bottomless multiwell structure configured such that when joined, a multiwell plate that matches SBS standards is formed to enable processing of microarrays using automated liquid handling systems.

ii. Coatings

In some embodiments, solid supports include a coating or multiple coatings including, but not limited to, diamond, gold, DLC, silicon nitride, or others.

An array surface can also include surface chemistry, including, but not limited to, surface attachment chemistry (e.g. alkanethiols on gold, silanes on glass, or co-modified alkenes on silicon or diamond surfaces) and/or bifunctional linker chemistry.

The immobilizing film can be comprised of, but is not limited to, nitrocellulose, polymer hydrogels, PVDF, nylon, silanes, alkane-thiols, nitrocellulose, ethylene glycols, biopolymers, gold, silver, TiO₂, silicon nitride, polymer, and/or chromium. The coating may also include multiple layers or combinations of these materials.

In some embodiments, solid supports are coated with a nitrocellulose solution (See e.g., U.S. Pat. No. 6,861,251 (Green, et al.), herein incorporated by reference). Preferably, both the nitrocellulose and the coated solid support are optically clear to enable the use of a wider range of optical detection configurations. Detection configurations that are particularly suited for optically clear detection include, but are not limited to, (1) configurations where optical excitation of fluorescence occurs above the coated solid support and emission detection occurs under the coated solid support (or opposite), and (2) configurations where an illuminating source is placed above the coated solid support and a camera is placed under the coated solid support (or opposite), or (3) any configuration where light is detected on the opposite side of the immobilized array.

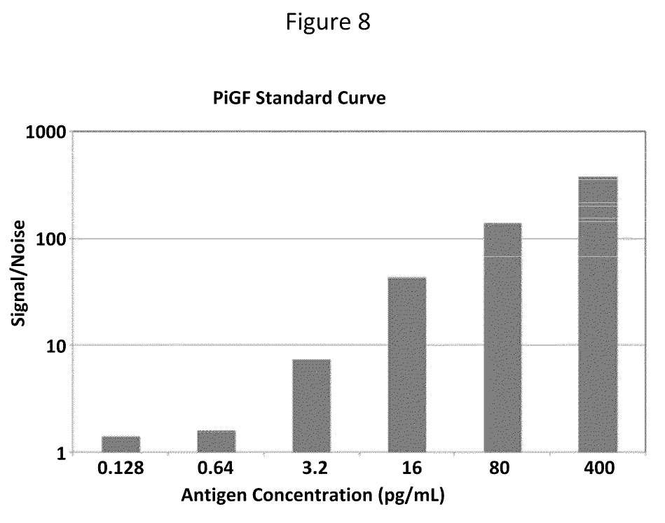

The present invention is not limited to a particular mechanism. Indeed, an understanding of the mechanism is not necessary to practice the present invention. Nonetheless, it is contemplated that the high signal-to-noise achieved using the optically clear nitrocellulose film is due to the unique characteristics of this type of film. For example, the roughness of the conventional surface chemistries on glass may render them less useful than nitrocellulose-containing coatings on plastic and glass solid supports for detection reactions that form a precipitate at discrete regions. Glass materials only allow sample analysis to occur on the same side of the solid matrix as the probe array. An example of the signal-to-noise achieved with the present assay is provided in FIG. 8. Accordingly, in some embodiments, the devices of the present invention provide a signal-to-noise of greater than 100, 200, 300, 400, 500, 600, 700, 800, 900, or 100, or from about 100 to 1000, 100 to 500, 200 to 500, 300 to 500. In some embodiments, these signal-to-noise ratios are achieved with a target molecule (e.g., antigen) concentration of from about 50 to 1000, 50 to 800, or 50 to 500 pg/ml, or from about 80 to 100, 80 to 800, or 80 to 500 pg/ml.

For example, in some embodiments, after extensive cleaning, the injection molded parts are spray-coated with a colloidal solution containing approximately 1% nitrocellulose (E. F. Fullam, Clifton Park, N.Y.). In particular embodiments, an ultrasonic spray coating system, such as that described in U.S. Pat. No. 7,235,307 (herein incorporated by reference), is used. In other embodiments, an aerosol spray can is used to coat array surfaces. In some embodiments, a solid film of approximately 3 microns on the substrates is formed. After coating with nitrocellulose, the coated slides are allowed to dry for approximately 2 hr. Preferred coated slides appeared optically clear after drying.

iii. Biological Molecules

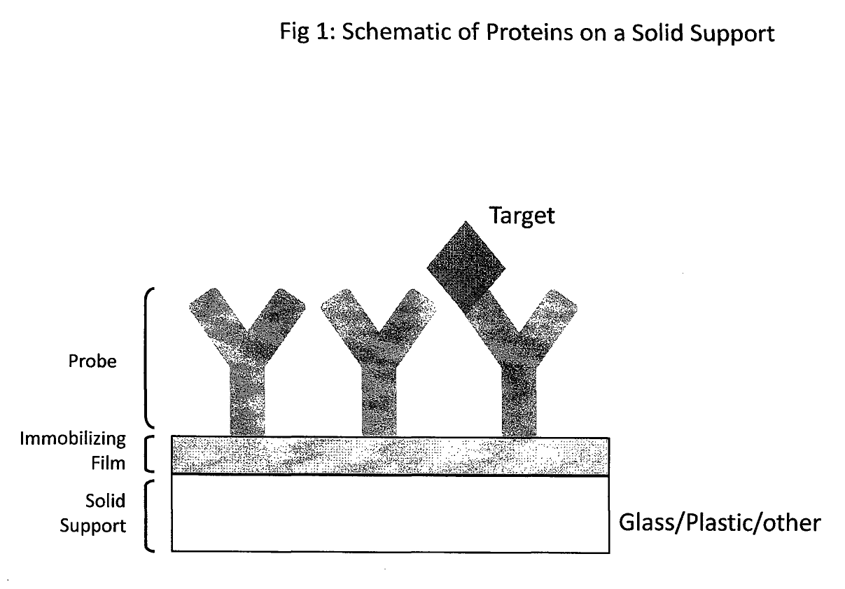

The arrays of embodiments of the present invention contain biological or chemical content, such as a protein, DNA, and/or a small molecule drug. The present invention is illustrated using an antibody based detection assay. However, the present invention is not limited to a particular biomolecule or small molecule for attachment to an array. Exemplary probes for immobilization include, but are not limited to, small molecules, nucleic acids, peptides, proteins, carbohydrates, antibodies, cells, etc. Some of the most common probe molecules include antibodies, peptides, lectins, proteins, aptamers, RNA, DNA, and small molecules. Spots of individual antibodies are positioned on the surface in discreet locations to form an array. A typical antibody probe array can have a density of 10 to 1000 probe spots per cm². FIG. 1 is a schematic showing a capture probe (in this case, an antibody) affixed to a solid support via an immobilizing film. Note that FIG. 1 is not to scale.

Besides photolithographic methods, robotic spotters are now the most common instrument used for creating arrays. In some embodiments, protein microarrays are fabricated using non-contact piezoelectric robotic spotters manufactured by companies such as the Piezorray (Perkin-Elmer, Shelton, Conn.), GeSim (NanoPlotter), Scienion and Aushon. Very high-density microarrays containing over one-hundred antibodies can be prepared using robotic spotters.

In some embodiments, replicate spots of each analyte are included to increase precision. In some cases, these replicates are scattered throughout the array to reduce spatial biases that may be present in a surface (See e.g., U.S. provisional patent application 60/972,928, herein incorporated by reference in its entirety).

### B. Detection

When a sample is applied to an array, target analytes (e.g. proteins or protein fragments found in serum or some other biological sample) are captured by the immobilized probes. Like other immunoassays, detection occurs using a detector molecule such as a labeled antibody followed by a reporter molecule, often containing a fluorescent label. As in other methods, a number of wash steps are performed in between steps to remove non-specifically bound proteins.

In certain embodiments, the detection step is colorimetric. In certain embodiments, the detection step involves a reaction that produces a precipitate (See e.g., US 20030124522, herein incorporated by reference). In particular embodiments the detection step uses signal detection involving horseradish peroxidase, gold-catalyzed silver deposition, or alkaline phosphatase. These compositions and methods can be used to perform multiplexed assays for analytes in patient and other test samples. In particular, these methods have applications for multi-analyte immunoassays to measure proteins in human serum and plasma using inexpensive solid supports and colorimetric detection instrumentation.

In some embodiments, the presence of a precipitate is detected using an array reader or other automated detection system. Array readers can measure a variety of optical outputs including, but not limited to, fluorescence, luminescence, radioactivity, colorimetric, optical waveguides, or surface plasmon resonance. In many cases, the bound molecule of interest is labeled in some way to make it detectable, such as with a fluorescent molecule, to generate an optical signal. Detection of optical signals is achieved using a variety of methods in these instruments, including, but not limited to, CCDs, CMOS chips, and/or PMTs. The concentrated light energy in an optical waveguide can be used to excite fluorescently labeled molecules with higher signal-to-noise than conventional approaches. This excitation (and the concomitant emission of light) is used to detect the presence of fluorescently labeled molecules in solution (like proteins or DNA) at very low levels.

There are several types of calorimetric detection instruments available for use with calorimetric microarrays. In general, calorimetric detection instruments are cheaper than confocal laser scanners because they use an inexpensive light source and detector and in many cases, avoid expensive optics by using a fixed focus. The most common calorimetric scanners are sold by Epson and Hewlett Packard and are commonly available at office supply stores. To use these scanners, slides are placed face down on the scanner bed. Samples are both illuminated and read by reflectance from below through a transparent glass surface. In this way, both transparent and opaque solid supports can be used with these types of calorimetric scanning devices.

In some embodiments, a colorimetric reader that scans through a transparent microarray slide to allow the detection of light grey-to-black spots generated from a precipitating reaction. These types of scanners allow the detection of arrays comprised of light grey-to-black spots that can be visualized first by the naked eye and subsequently scanned. The grey or black level intensity is related to the quantity of target molecule that are hybridized or adsorbed onto an array spot. This type of technology can be used to detect any type of precipitating reagents using an optically clear slide. These instruments can now be purchased commercially, usually for less than a third of the price of a typical fluorescent microarray scanner. One example of an instrument that can read calorimetric arrays is Eppendorf's SILVERQUANT scanner, which can be used to scan standard microscope slides (25×75 mm). In other embodiments, a colorimetric reader that scans through a transparent, SBS-compatible plate with arrays printed on the bottom to allow the detection of light grey-to-black spots generated from a precipitating reaction is used. One such instrument, the APiX VistaScan, is available from Gentel (Madison, Wis.), which allows scanning of transparent, SBS-compatible 96- or 384-well plates with arrays printed on them as well as scanning of standard microarray slides. Additionally, flatbed scanners that are capable of scanning in a transmission mode can also scan through a transparent microarray slides to allow the detection of light grey-to-black spots generated from a precipitating reaction. Examples of scanners capable of transmission scanning include the EPSON 4490, EPSON V700, and Cannon CanoScan 8800F. In many cases, these transmission-based flatbed scanners can achieve equivalent or superior S/N compared to other colorimetric scanners. In testing performed in our laboratory, we have shown that reflection-based flatbed scanners yield inadequate S/N compared to transmission-based colorimetric scanners.

In another embodiment, we have performed calorimetric assays using a 96-well hybrid microarray and multiplexing device called Smartplex™, (ThermoScientific). The device is fully compatible with microplate- and liquid-handling automation uses a unique approach to incorporate coated planar substrates such as aminosilane, epoxy silane, and poly-L-lysine coated glass. Nitrocellulose coated substrates such as the PATH slide and clear nitrocellulose coated glass or plastic substrates can also be used with Smartplex. The Smartplex device uses a three-piece design that incorporates (1) a frame for holding a planar substrate, (2) a rigid substrate, and (3) a bottomless, 96-well top with adhesive on the bottom that forms 96-chambers when joined to the substrate. For array printing, the bottom frame holds can be used to hold the substrate in place. For sample processing using standard liquid handling automation, the 3-piece device is assembled to resemble an SBS-compatible 96-well microplate. The fully assembled 3-piece device can be read scanned in a fluorescent scanner such as the Tecan LS Reloaded. The APiX VistaScan colorimetric reader can also scan the fully assembled 3-piece device provided optically clear substrates and surface chemistries are used. Transmission-based flatbed scanners can be used to read the Smartplex device provided the bottom frame is removed for scanning on the flatbed scanner. Without the capability to remove the bottom frame, the calorimetric array would be beyond the focal length of commercially available flatbed scanners. Therefore, use of the 3-piece design with colorimetric experiments has unique advantages and enables use of very low-cost transmission-based flatbed scanners. Reflection-based flatbed scanners do not have the focal length to image a Smartplex or standard 96-well plate.

Once read by a scanner or imager, the array readout is processed in order to transform the image into quantitative data. Many software programs exist for array image processing, including ArrayVision (Imaging Research Inc/GE Healthcare Life Sciences), ScanArray Express (PerkinElmer Life Sciences Waltham, Mass.), MicroVigene (VigeneTech. Inc, Carlisle, Mass.). These programs include “spot finding” algorithms and turn microarray images into values. These programs often have features that subtract array background noise from spot values. Once values are obtained for each spot, values from standard calibration curves can be used to generate a curve-fit, from which the user can back-calculate the concentration of analytes in the sample of interest.

### C. Kits and Systems

In some embodiments, the present invention provides kits and systems for performing and analyzing array data. In some embodiments, the kits and systems comprise all of the components necessary, sufficient, or useful for generating, performing and analyzing arrays. For example, in some embodiments, kits and systems include all of the substrates (e.g., arrayed substrates), reagents, components, buffers, normalization standards, and controls needed for performing assays. In some embodiments, kits and systems further comprise software for collecting and analyzing data from arrays. In some embodiments, kits and systems comprise instructions for using the kits. In some embodiments, systems comprise automation equipment (e.g., robotics, etc.) for automating assays.

II. Diagnostic and/or Clinical Methods

As described above, embodiments of the present invention provides devices and systems for generation and detection of high density arrays. As described above, in some embodiments, multiplexed assays are performed. The present invention is not limited to detection of a particular analyte. The methods and compositions of the present invention find use in the detection of any number of diagnostic and research applications.

The present invention is not limited to a particular detection assay. Quantitative multiplex immunoassays, single capture antibody arrays, multiplex serological assays, and biomarker profiling are all contemplated. Examples include, but are not limited to, immunoassays where antibodies or antigens are affixed to the array surface, nucleic acid based assays where a nucleic acid or probe is affixed to the array surface, protein-protein interaction assays where a protein is affixed to the surface, small molecule detection assays where a small molecule or capture reagent is affixed to the array surface and drug screening assays where a small molecule or target enzyme is affixed to the array surface. In particular, embodiments of the present invention (See e.g., Example 1) have applications for multi-analyte immunoassays to measure proteins in human serum and plasma using inexpensive solid supports and colorimetric detection instrumentation.

In some embodiments, protein arrays are used to measure protein abundance. Protein abundance is most commonly measured using protein capture molecules such as antibodies, aptamers, antibody fragments, and others. Capture molecules can be immobilized on surfaces and used to quantify protein abundance in a wide variety of samples, including, but not limited to, saliva, blood, plasma, serum, urine, cell lysates, tissue, or other biological fluids. Fluorescence-, luminescence-, and colorimetric-based detection using planar arrays have proven to be highly sensitive and rapid methods for multiplexed protein detection. The attractive cost, use of less sample, improvement in efficiency and chain-of-custody benefits of multiplexed protein measurement in a single sample has helped these assay become much more common, particularly measurements of cytokine proteins in human serum and plasma. However, prior to the present invention, problems with assay sensitivity and reproducibility persist and have limited the broader utility and hence acceptance of these assays.

Protein analytes can be detected using a variety of detection steps that may include detector antibodies (commonly a biotinlyated, fluorescent, or otherwise-labeled monoclonal or polyclonal antibody), secondary antibodies (such as a biotinlyated, fluorescent- or otherwise labeled anti-species antibody), and/or a detection reagent (such as fluorescent- or otherwise-labeled streptavidin, a substrate, or precipitate).

The present invention provides several methods for improving the efficiency of obtaining protein array results. Often, a single planar surface can contain multiple arrays to enable processing of standard calibration curves and/or multiple patient or test samples on a single slide. These multi-array surfaces are usually coupled to multiplexing devices (also called separators) that separate samples by forming multiple, independent chambers or wells. Examples of multiplexing devices include the ProPlate™ (Grace Bio-Labs, Inc. Bend, Oreg.), FASTframe™ (Publication # WO2005060678 or application Ser. No. 10/737,784), or SIMplex™ products (Gentel Biosciences, Madison, Wis.). Commonly, multiplexing devices separate a single 3″×1″ microarray slide into sixteen chambers (e.g. 2×8 format). The Proplate™, FASTframe™, and SIMplex64™ devices secure four slides (sixteen chambers each) to form a sixty-four well device. These devices have been designed to fit within the standard footprint of a multi-well plate as established by the Society of Biomolecular Sciences (SBS Standards). The footprint for most multiwell plates is approximately 85 mm×125 mm with wells located in a standardized format depending upon the total number of wells. In this format, researchers can incorporate an eight-point standard curve- and process up to 56 samples using a single, 64-well plate. Alternatively, a researcher could incorporate two eight-point standard curves and process up to sixteen samples in triplicate using a single, 64-well plate to achieve higher precision.

More recently, researchers have coupled larger format slides to separators to emulate the 96-well plate format standard (U.S. Pat. No. 7,063,979, United States Patent Application 20050277145; each of which is herein incorporated by reference) established by SBS. This also includes the Smartplex™ device (ThermoScientific). This format has the advantage of being more fully compatible with robotic liquid handling instruments and enables the processing of additional samples. For example, a researcher could incorporate a single eight-point standard curve and process up to 88 samples using a single 96-well plate.

All of these multiplexing methods allow sample processing using automated liquid handling robots to enable rapid and efficient collection of multi-analyte data from many samples. Additionally, automation helps reduce assay variation (thus enabling more precise quantitation).

In some embodiments, the present invention provides methods for differential diagnosis of a disorder or identification of a patient subset, identification of potential responders to a specific drug, targeting of specific therapies, identifying individuals at risk for adverse events, and monitoring individual responses to drugs. These applications require very robust protein quantification technologies with high levels of accuracy and precision to meet this need.

Accordingly, in some embodiments, the present invention provides methods to normalize microarray data across different wells and within a single well (See e.g., above description of replicate assays).

The applications of the present invention described herein are examples and are not intended to limit the present invention. The methods of the present invention are suitable for detection and quantitation of any number of targets and analytes.

### EXPERIMENTAL

The following examples are provided to demonstrate and illustrate certain preferred embodiments and aspects of the compositions and methods disclosed herein, but are not to be construed as limiting the scope of the claimed invention.

### Example 1

### Quantitative Multiplexed Immunoassay to Measure Human Cytokines

This example describes the use of precipitating reagents and optically clear nitrocellulose-coated plastic slides to perform a quantitative multiplexed immunoassay to measure human cytokines in patient serum. For comparison, a similar assay was performed on a commercially available PATH™ protein microarray slide (Gentel Biosciences, Madison, Wis.) and fluorescence reagents.

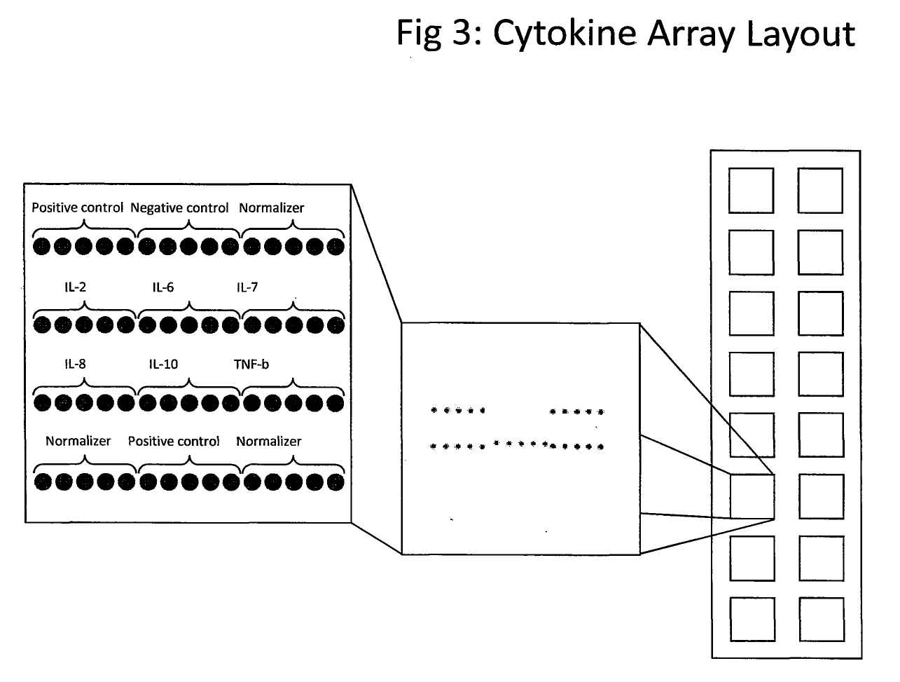

Capture antibodies to six human cytokines were printed in sixteen sub-arrays on both optically clear nitrocellulose-coated plastic slides and PATH™ slides (see FIG. 3). After printing, arrays were allowed to incubate for several days and subsequently blocked using Gentel Block Buffer (Gentel Biosciences). After blocking, the coated plastic slides and PATH™ slides were assembled in SIMplex64™ multiplexing devices to enable processing of sixteen samples per slide. Antigens were diluted in a serum matrix (PBS+10% FBS) and applied to separate sample wells to create a standard dilution curve. Internal normalization standards are also included in all wells to improve sensitivity and reproducibility. To do this, solutions in all wells are spiked with β-galactosidase normalization reagent such that the final concentration of β-galactosidase was equivalent in all wells. Next, a cocktail of biotinylated detector antibodies was incubated in each well, followed by washing of the slides.

For optically clear nitrocellulose coated plastic slides, the Silverquant™ detection kit was used. The Silverquant™ detection kit includes all required reagents to perform gold particle catalyzed silver deposition. Briefly, the slides were placed into the Silverquant™ box and washed per kit instructions, blocked with the Silverquant™ blocker for 10 min, and then incubated with the anti-biotin-gold conjugate Ab for 45 min. Following more washes, the slides were incubated with the Silverquant™ silver staining reagent for 5 min and then washed with water and dried. Readout was performed using an Eppendorf Silverquant™ Scanner following manufacturer's instructions.

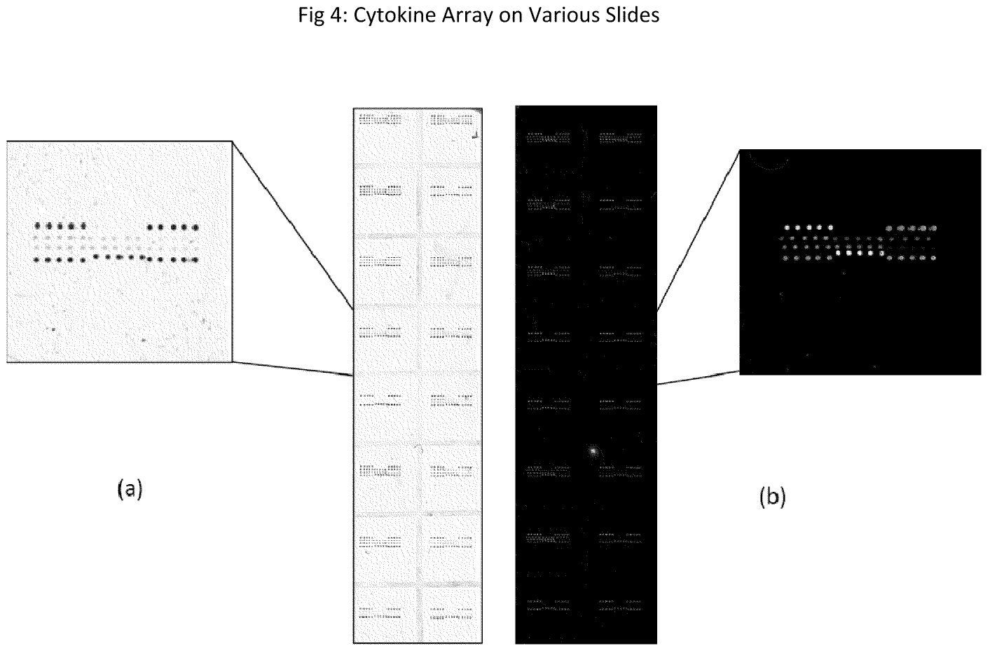

For PATH™ slides, streptavidin DY547 (Dyomics GmBH, Germany) was used at a concentration of 10 ng/mL. The slides were incubated with the SA-Dy547 solution and then washed, disassembled from the SIMplex64 device and dried. Readout was performed using a Tecan LS Reloaded using 532 nm excitation. An example of each slide type after the human cytokine assay was completed is shown in FIG. 4.

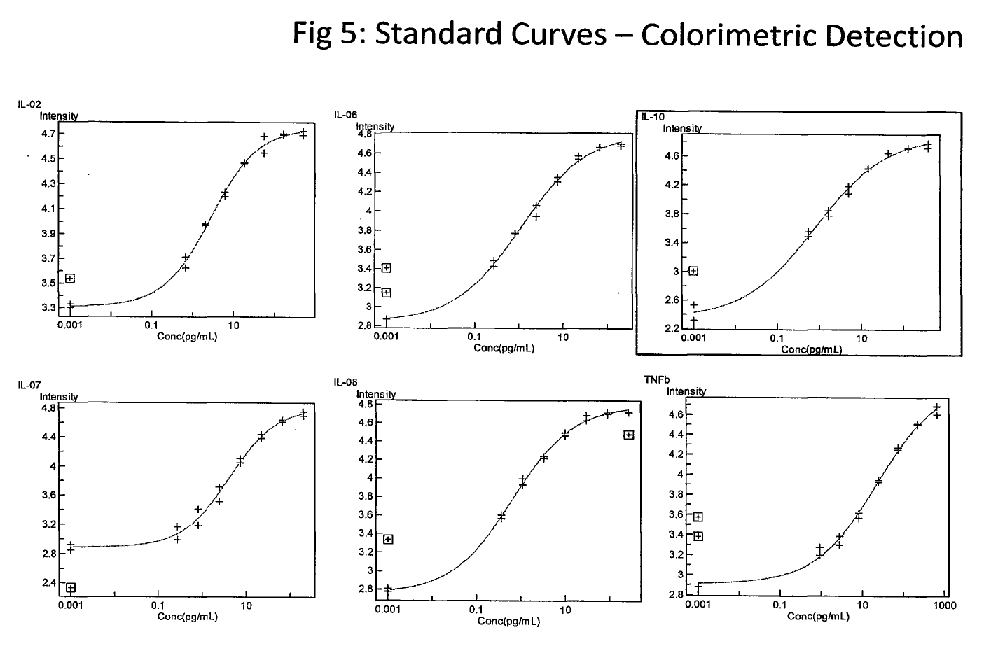

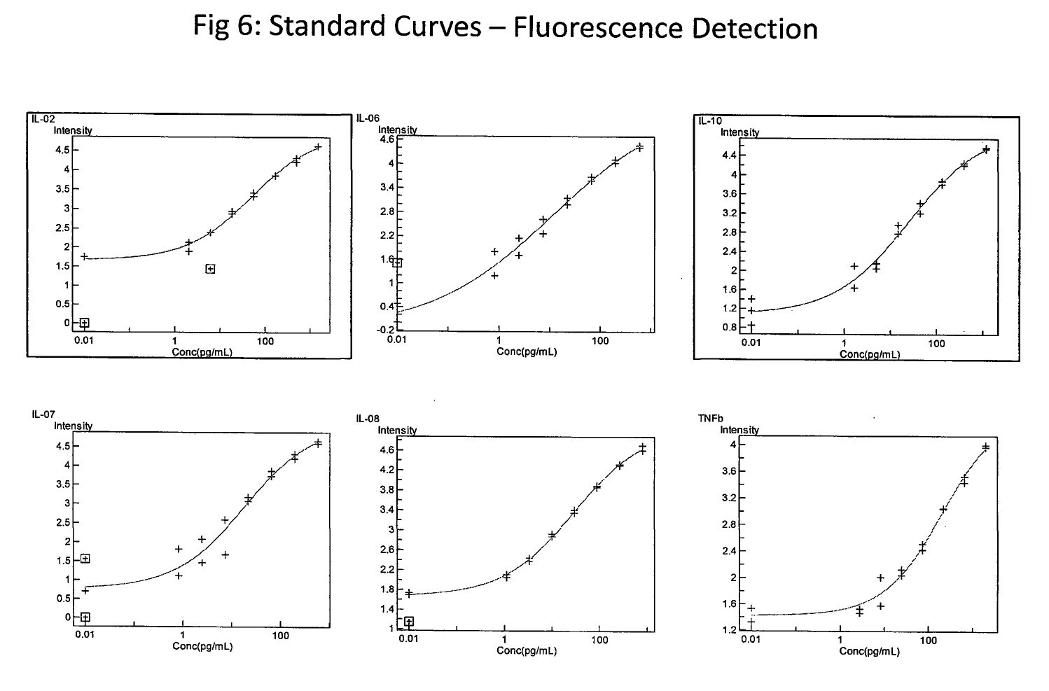

Standard curves for both the coated plastic substrates and PATH™ slides are shown in FIG. 5 and FIG. 6. It should be noted from these data that the standard curves generated from precipitating reagents and optically clear nitrocellulose-coated plastic substrates yield much more discrimination. The antigens for the most concentrated solution in the standard curve ranged from 0.6-2.0 ng/mL (fluorescence) or 0.2-0.67 ng/mL (calorimetric). The subsequent six standards were 1:2 serial dilutions of this sample, with the eighth standard being a blank (i.e. no antigens present).

Further quantitative analysis indicated significantly improved reproducibility and sensitivity resulting from using precipitating reagents and optically clear nitrocellulose-coated plastic substrates. This is evident in the comparison of the limit-of-detection (LOD), and percent coefficient of variation (% CV), for the two approaches. Table 1 shows the calculated LODs for six human cytokines using a fluorescence-based assay and PATH™ slides as well as a colorimetric assay and nitrocellulose-coated plastic slides. LOD was calculated using the blank signal plus two standard deviations in a 4-parameter fit of the standard curve. % CV was calculated spot-to-spot (n=5 spots), well-to-well (n=4 wells across four slides), and day-to-day (n=3 days). For the reproducibility data shown in Tables 2-4, the % CV were calculated from data from standards #1-5 from the standard curves. The lowest three standards were not included because the average signals were small and thus the % CV were significantly impacted by small variations.

As is seen from Table 1, it is evident from these data that the use of precipitating reagents and optically clear nitrocellulose-coated plastic slides to perform a quantitative multiplexed immunoassay significantly improves sensitivity compared to a similar fluorescence-based assay. The present invention is not limited to a particular mechanism. Indeed, an understanding of the mechanism is not necessary to practice the present invention. Nonetheless, it is contemplated that one reason for the increased sensitivity of the assay compared to fluorescence-based assays and similar assays performed on a silanized glass slide is due to the unique properties of the colloidal nitrocellulose film, which creates a very low background signal when used in a precipitating assay.

Further benefits can be noted in assay reproducibility. Tables 2-4 show that precipitating reagents and optically clear nitrocellulose-coated plastic slides yield lower spot-to-spot % CVs, lower well-to-well % CVs and roughly equivalent day-to-day % CVs compared to a similar fluorescence-based assay.

TABLE 1
Limit of Detection for each method (pg/mL).

| | | Gentel |
|---|---|---|
| | Gentel | PATH ™ |
| Antigen | Plastic Colorimetric | Fluorescence |
| IL-2 | 0.050 | 0.11 |
| IL-6 | 0.022 | 0.13 |
| IL-7 | 0.22 | 0.29 |
| IL-8 | 0.009 | 0.042 |
| IL-10 | 0.011 | 0.13 |
| TNF-b | 1.5 | 7.5 |
| SUM | 1.812 | 8.202 |

TABLE 2
Spot-to-Spot Reproducibility for each method (% CV).

| | | Gentel |
|---|---|---|
| | Gentel | PATH ™ |
| Antigen | Plastic Colorimetric | Fluorescence |
| IL-2 | 6% | 7% |
| IL-6 | 5% | 14% |
| IL-7 | 7% | 8% |
| IL-8 | 4% | 11% |
| IL-10 | 5% | 13% |
| TNF-b | 33% | 14% |
| SUM | 59% | 67% |

TABLE 3
Well-to-Well Reproducibility for each method (% CV).

| | | Gentel |
|---|---|---|
| | Gentel | PATH ™ |
| Antigen | Plastic Colorimetric | Fluorescence |
| IL-2 | 10% | 10% |
| IL-6 | 9% | 21% |
| IL-7 | 13% | 28% |
| IL-8 | 8% | 11% |
| IL-10 | 9% | 19% |
| TNF-b | 9% | 17% |
| SUM | 57% | 105% |

TABLE 4
Day-to-Day Reproducibility for each method (% CV).

| | | Gentel |
|---|---|---|
| | Gentel | PATH ™ |
| Antigen | Plastic Colorimetric | Fluorescence |
| IL-2 | 14% | 14% |
| IL-6 | 11% | 12% |
| IL-7 | 18% | 12% |
| IL-8 | 8% | 13% |
| IL-10 | 11% | 14% |
| TNF-b | 30% | 19% |
| SUM | 92% | 84% |

### Example 2

### Der p 2 Mediated Quantitative Determination of Allergen-Specific IgE in Human Serum

This example describes the use of precipitating reagents and optically clear nitrocellulose-coated plastic slides to make quantitative determinations of allergen-specific IgE titers. A Chimeric anti-Der p 2 Immunoglobulin E (IgE) (Indoor Biotechnologies) was used as a surrogate for quantitative determinations encompassing a large range of allergen-specific IgE titers in patient serum. Here, quantitation capability using both precipitating reagents and optically clear nitrocellulose-coated plastic slides and fluorescence-based measurements and a commercially available PATH™ slide were compared using the Der p 2 standard curve.

To do this, recombinant allergens including Cat (Fel d 1), Silver Birch (Bet v 1a, Bet v 2), Timothy Grass (Phl p 1, Phl p 2, Phl p 5a, Phl p 6), mold (Alternaria alternata, Alt a 1), dust mite (Der p 1, Der p 2, Der f 1), Dog (Can f 1) (Indoor Biotechnologies) were immobilized on a microarray using a robotic microarrayer. Recombinant β-galactosidase was also included in the array for use as an internal normalization standard. Arrays were printed in sixteen sub-arrays on both optically clear nitrocellulose coated plastic slides and PATH™ slides. After printing, arrays were allowed to incubate for four days and subsequently blocked using GenTel™ Block Buffer. After blocking, the coated plastic slides and PATH™ slides were assembled in SIMplex64 multiplexing devices to enable processing of sixteen sample wells for each slide and to facilitate automated washing.

Chimeric anti-Der p 2 IgE was diluted in a serum matrix (PBS+10% FBS) and applied to separate sample wells to create standard dilution curves. Internal normalization standards were included in all wells to improve sensitivity and reproducibility. To do this, solutions in all wells were spiked with β-galactosidase normalization reagent such that the final concentration of β-galactosidase was equivalent in all wells. Next, a biotinylated anti-human IgE-IgG was incubated on the array, followed by washing and detection.

For optically clear nitrocellulose coated plastic slides, the Silverquant™ detection kit was used. Briefly, the slides were placed into the Silverquant™ box and washed per kit instructions, blocked with the Silverquant™ blocker for 10 min, and then incubated with the anti-biotin-gold conjugate Ab for 45 min. Following more washes, the slides were incubated with the Silverquant™ silver staining reagent for 5 min and then washed with water and dried. Alternately, the steps performed in the Silverquant™ box can be performed in the SIMplex device. Readout was performed using an Eppendorf Silverquant™ Scanner. Readout was repeated using the Gentel APiX VistaScan Reader and an EPSON V700 flatbed scanner.

For PATH™ slides, streptavidin DY649 (Dyomics GmBH, Germany) was used at a concentration of 10 ng/mL. Readout was performed using a Tecan LS Reloaded using 633 nm excitation.

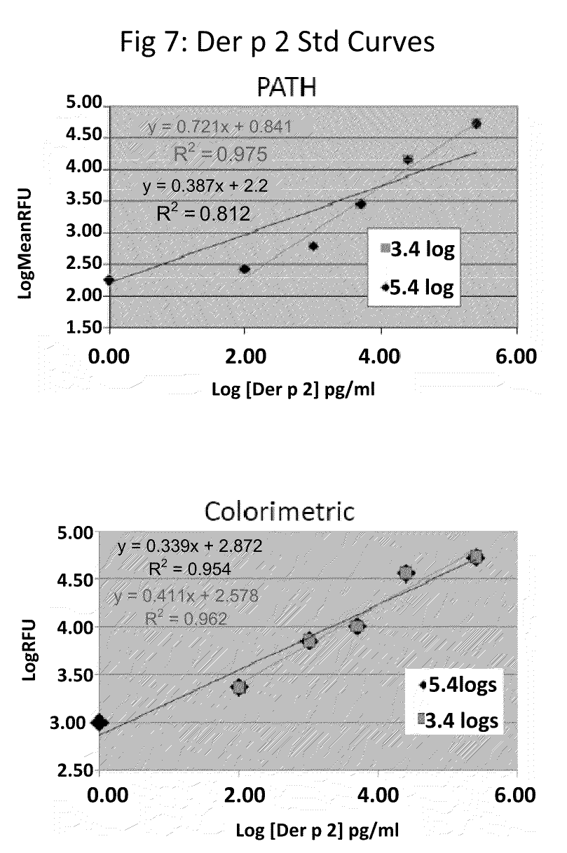

Standard dilution curves for Chimeric anti-Der p 2 IgE on both the coated plastic substrates and PATH™ slides are shown in FIG. 7(a) and FIG. 7(b). It should be noted from these data that the standard curves generated from precipitating reagents and optically clear nitrocellulose-coated plastic substrates yield much more discrimination.

Further quantitative analysis indicated significantly improved reproducibility and sensitivity resulting from using precipitating reagents and optically clear nitrocellulose-coated plastic substrates. This is evident in the comparison of the limit-of-detection (LOD), coefficient of variation (CV), and goodness-of-fit (R²) for the two approaches. LOD was calculated using the blank signal plus two standard deviations in a 4-parameter fit of the standard curve. LOQ was calculated using the blank signal plus eight standard deviations in a 4-parameter fit of the standard curve. Table 5 shows results based on a standard curve generated using Chimeric anti-Der p2 IgE.

TABLE 5

| | | | Dynamic | | |
|---|---|---|---|---|---|
| Experiment | LOD | LOD | Range | Avg % CV | |
| Performed | (pg/ml) | (IU/ml) | (Logs) | (range) | R² |
| Initial | 38.70 | 0.016 | 2.7 | 6.28, (10, 2, | 0.881 |
| Plastic | | | | 23, 4, 2, 1, | |
| Colorimetric | | | | 2) | |
| Optimized | 6.048 | 0.003 | 5.4 | 18.4, (1, 7, | 0.954 |
| Plastic | | | | 39, 6, 37, | |
| Colorimetric | | | | 18, 21) | |
| Optimized | 89.23 | 0.037 | 3.4 | 9.43 (5, 6, | 0.975 |
| Fluorescence | | | | 23, 7, 7, 5, | |
| PATH | | | | 12, 8) | |

All publications and patents mentioned in the above specification are herein incorporated by reference. Various modifications and variations of the described devices, compositions, methods, systems, and kits of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in art are intended to be within the scope of the following claims.

We claim:

1. A method for performing a multiplexed assay, comprising:
a) contacting a substrate with a sample comprising a target molecule under conditions such that said target molecule binds to a capture molecule, wherein said substrate comprises an array of said capture molecules affixed to an optically clear coating of nitrocellulose on said substrate;
b) contacting said arrays with reagents under conditions such that a precipitate is formed where said target molecule is bound to said capture molecule.

2. The method of claim 1, further comprising the step of c) determining the presence of said precipitate in discrete regions on said array, wherein the presence of said precipitate is indicative of the presence of said target molecule in said sample.

3. The method of claim 2, further comprising the step of quantifying the level of said target molecule in said sample.

4. The method of claim 1, wherein said substrate is plastic.

5. The method of claim 1, wherein said substrate is glass.

6. The method of claim 1, wherein said precipitate is formed from the precipitate of a metallic compound upon the complex of said target molecule and said capture molecule.

7. The method of claim 6, wherein said metallic compound is a magnetic metallic compound.

8. The method of claim 6, wherein said precipitate is formed via a chemical reduction of silver in the presence of colloidal gold particles coupled to the bound target compound.

9. The method of claim 2, wherein said determining the presence of said precipitate comprises the use of a colorimetric reader.

10. The method of claim 9, wherein said reader is CCD or CMOS based.

11. The method of claim 1, wherein said array is selected from the group consisting of a 3″×1″ slide, a 96-well array plate, and a 384-well plate.

12. The method of claim 2, wherein said determining the presence of said precipitate comprises a detection assay selected from the group consisting of gold-catalyzed silver deposition, horseradish peroxidase, AP, and tyramide signal amplification.

13. The method of claim 1, wherein said capture molecule is selected from the group consisting of a nucleic acid, a protein, and a small molecule.

14. The method of claim 14, wherein said protein is an antibody.

15. A substrate comprising an array of capture molecules affixed to an optically clear coating of nitrocellulose on said substrate.

16. The substrate of claim 15, wherein said substrate is plastic.

17. The substrate of claim 15, wherein said substrate is glass.

18. The substrate of claim 1, wherein said capture molecule is selected from the group consisting of a nucleic acid, a protein, and a small molecule.

19. A system, comprising:
a) a substrate comprising an array of capture molecules affixed to an optically clear coating of nitrocellulose on said substrate; and
b) a device for detection of target molecules bound to said capture molecules.

20. The system of claim 19, further comprising reagents that form a precipitate where said target molecule is bound to said capture molecule.

21. The system of claim 19, wherein said device detects the presence of a precipitate of said capture molecule and said target molecule on said array.

22. The system of claim 19, wherein said device quantifies the level of said target molecule.

23. The system of claim 19, wherein said substrate is plastic.

24. The system of claim 19, wherein said substrate is glass.

25. The system of claim 19, wherein said device is a calorimetric reader.

26. The system of claim 25, wherein said reader is CCD or CMOS based.

27. The system of claim 19, wherein said array is selected from the group consisting of a 3″×1″ slide, a 96-well array plate, and a 384-well plate.

28. The system of claim 19, wherein said capture molecule is selected from the group consisting of a nucleic acid, a protein, and a small molecule.

29. The system of claim 28, wherein said protein is an antibody.

30. A kit, comprising:
a) a substrate comprising an array of capture molecules affixed to an optically clear coating of nitrocellulose on said substrate; and
b) a device for detection of target molecules bound to said capture molecules, and
c) reagents that form a precipitate where said target molecule is bound to said capture molecule.
